(19) United States
(12) Patent Application Publication
(10) Pub. No.: US 2004/0008611 A1
(43) Pub. Date: Jan. 15, 2004

(54) Copy controlled information recording disk

(76) Inventor: Nobuchika Ochi, Yokohama-shi (JP)

Correspondence Address: CONNOLLY BOVE LODGE & HUTZ LLP, SUITE 800, 1990 M STREET NW, WASHINGTON, DC, 20036-3425, US

(21) Appl. No.: 10/460,377

(22) Filed: Jun. 13, 2003

(30) Foreign Application Priority Data
Jun. 13, 2002 (JP) 2002-172438

(51) Int. Cl. G11B 7/24

(52) U.S. Cl. 369/275.3

(57) ABSTRACT

A copy controlled information recording disk 3 having a session structure that is composed of a first lead-in area 2a1, a first program area 2b1, a first lead-out area2c1, a second lead-in area 2a2, a second program area 2b2, and a second lead-out area 2c2. They are formed continuously in serial concentric circle in the radial direction. The copy controlled information recording disk 3 is characterized in that each reflection coefficient of the first and second lead-in areas 2a1, 2a2 and the first and second lead-out areas 2c1, 2c2 is set to be equal to a reflection coefficient of the first and second program areas 2b1, 2b2, and that the reflection coefficient is set to be in a value that physical positions of each area is hard to be distinguished visually.

### BACKGROUND OF THE INVENTION

1. Field of the Invention

The present invention relates to a copy controlled information recording disk which contains a recorded information to be protected under copyrights, and is restricted to have such the recorded information to be copied and/or reproduced illegally.

2. Description of the Related Art

An information recording disk so called “compact disk” (hereinafter referred to as “CD”) is in widespread use as an inexpensive recording medium for distributing audio and program information, and suitable for mass-production.

An information recorded in a CD, for example, is protected under copyrights. However, the information can illegally be duplicated into another recording medium without a permission of copyright holders that they suffered from damages caused by such unauthorized duplication of CDs.

For example, there provided a copy controlled CD having a copy protection system, which restricts an illegal reproduction or duplication of information data recorded in multi-session format in the CD.

FIG. 1 is an example for explaining structure of an information recording disk according to a related art. In FIG. 1, an information recording disk 1 is composed of a lead-in area 1a, a program area 1b and a lead-out area 1c in serial concentric circle.

For example, the information recording disk 1 has a data structure of single-session format of which structure is same as a conventional audio CD.

FIG. 2 is an example for explaining another structure of an information recording disk according to the related art. In FIG. 2, an information recording disk 2 is composed of a session area S11 and another session area S22 where an information is recorded serial concentric circle. The session S1 has a format structure identical to the audio CD that has a lead-in area 2a1, a program area 2b1 and a lead-out area 2c1. The program area 2b1 contains a program information of audio data to be protected under copyright.

The other session S2 has a format structure identical to a data CD (for example, CD-ROM) that has a lead-in area 2a2, a program area 2b2 and a lead-out area 2c2.

The program area 2b2 or the lead-in area 2a2 is recorded with data for protecting the information recorded in the program area 2b1 from unauthorized copy.

As the data for copy protection are recorded in the program area 2b2 or the lead-in area 2a2 in the session area S22, the information recording disk 2 is protected from unauthorized copy that the information in the program area 2b1 can not be recognized properly to duplicate the same.

The information recording disk 2 contains multi-session format information, wherein the information format in the session areas S11 and S22 are different from each other. In the case of session area S11, it is recorded with information having the same format of audio data for audio CD. In this sense, the program area 2b1 is recorded in the format different from the format of lead-in and lead-out areas 2a1 and 2c1, wherein the difference of the recording format provides different reflection coefficient. Consequently, the program area 2b1 can easily distinguished from the lead-in and lead-out areas 2a1 and 2c1. In other words, the program area 2b1 recorded with an information which should be protected can be visibly spotted.

In the case of session area S22, it is recorded with information having the same format of information data for CD-ROM. In this sense, the program area 2b2 and lead-in and lead-out areas 2a2 and 2c2 are recorded in the same data format that the reflection coefficient of the session S2 becomes even.

The program area 2b1 is recorded with audio data having 1 byte length data sequence, which seldom becomes the same sequence of data. For example, the audio data seldom provides a sequence of “0x00”, “0x00”, “0x00”, (wherein “0x00” is a hexadecimal data representing “00”), which is a sequence of fixed data. The sequence of data depends on an audio information that the sequence of data becomes, for example, “0x02”, “0xFA”, “0x17”, “0xA0”, which is a sequence of unfixed data.

In contrast, the lead-in and lead-out areas 2a1 and 2c1 are recorded with an information having the sequence of fixed data. The difference of data sequence provides different diffraction light (or reflection light) when illumination light for reproducing information from the CD is illuminated on the CD. Consequently, each area in the session S1 has different reflection coefficient.

The difference of reflection coefficient caused by the sequence of fixed data and unfixed data can easily and visually be spotted. For example, the reflection coefficient of the lead-in and lead-out areas 2a1 and 2c1 is 75% respectively, and the reflection coefficient of the program area 2b1 is 76.5%. The difference of the reflection coefficient is 1.5%.

In other words, the physical position of the program area 2b2 can also be spotted visually. In this sense, the physical position of the program area 2b2 can be covered physically that the copy controlled CD can be treated as if it is an ordinary audio CD. For example, the physical position of the program area 2b2 is daubed with marker or other writing instruments.

### SUMMARY OF THE INVENTION

In view of the foregoing problem of the related art, it is one aspect of the present invention to provide a copy controlled information recording disk having a session structure comprising: a lead-in area; a program area; and a lead-out area, formed continuously in serial concentric circle in the radial direction, the copy controlled information recording disk is further characterized in that each reflection coefficient of the lead-in area and the lead-out area is set to be equal to a reflection coefficient of the program area, and that the reflection coefficient is set to be in a value that physical position of each area is hard to be distinguished visually.

Other object and further features of the present invention will be apparent from the following detailed description when read in conjunction with the accompanying drawings.

### BRIEF DESCRIPTION OF DRAWINGS

FIG. 1 is an example for explaining structure of an information recording disk according to a related art.

FIG. 2 is an example for explaining another structure of an information recording disk according to the related art.

FIG. 3 is a diagram for explaining structure of an information recording disk according to an embodiment of the present invention.

FIG. 4 is a diagram for explaining an example of EFM frame format data according to the related art.

FIG. 5 is a diagram for explaining an example of EFM frame format data according to the present invention.

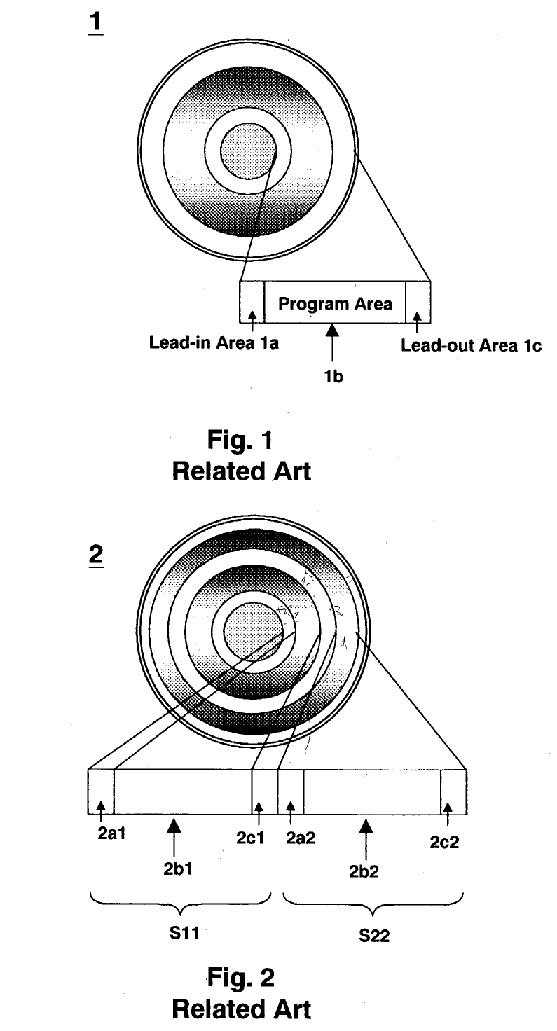

### DETAILED DESCRIPTION OF THE PREFERRED EMBODIMENTS

[First Embodiment]

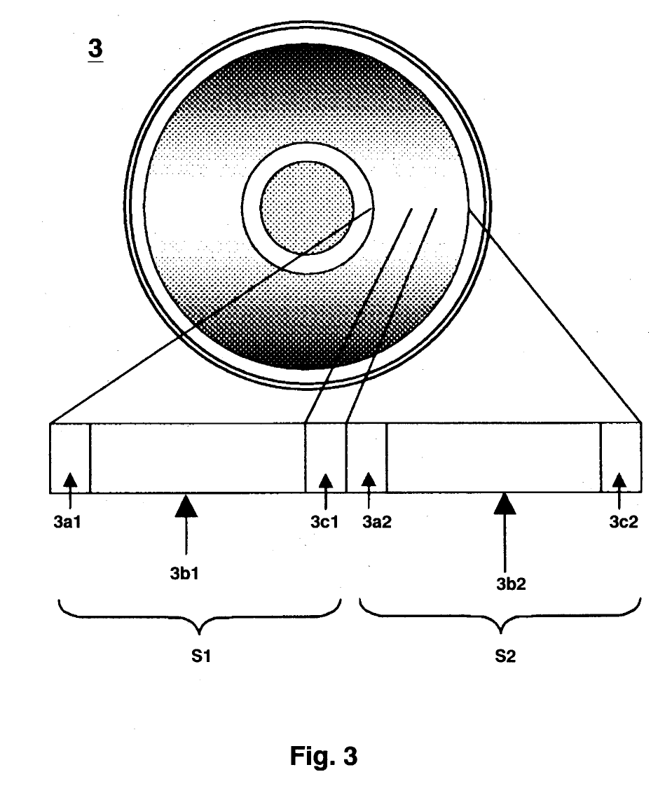

FIG. 3 is a diagram for explaining structure of an information recording disk according to an embodiment of the present invention.

In FIG. 3, an information recording disk 3 is composed of a first session area S1 and a second session area S2 where an information is recorded in serial concentric circle. The first session area S1 has a lead-in area 3a1, a program area 3b1 and a lead-out area 3c1. The second session area S2 has a lead-in area 3a2, a program area 3b2 and a lead-out area 3c2.

The embodiment of the present invention is to provide the lead-in area 3a1 and lead-out area 3c1 having a sequence of unfixed data. In this sense, the border of each lead-in area 3a1 and lead-out area 3c1 can not visibly recognized.

The information recording disk 3 has at least the first session area S1 in the inner concentric circle and the second session area S2 in the outer concentric circle contiguous to the first session area S1.

A lead-in data in the lead-in area 3a1 and a lead-out data in the lead-out area 3c1 are unfixed data which data contiguous to each other is different.

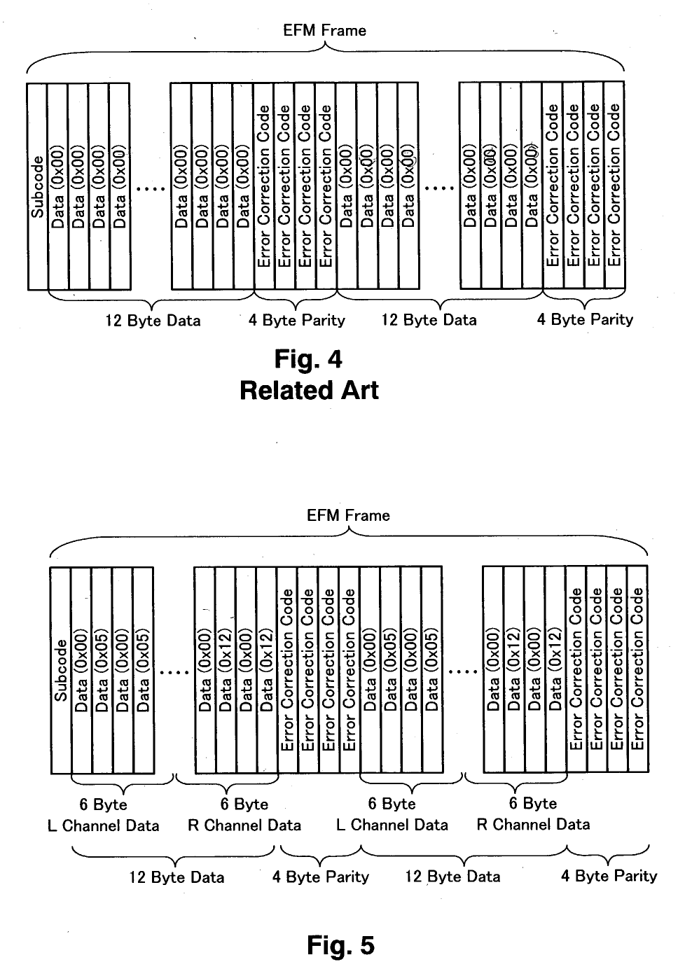

The lead-in and lead-out areas are recorded with an information, for example, EFM frame format data. FIG. 4 is a diagram for explaining an example of EFM frame format data.

The EFM frame is a group of 33 symbols where one symbol corresponds to 1 byte (8 bit) data. The EFM frame has a subcode in the top portion which indicates an address or data form (whether it is an audio data or ROM data etc.) of the recorded information in 1 byte length. In the case that the data form is an audio data, EFM frame becomes 24 byte length, recorded with an information data in 12 byte each. 4 byte of an error correction data having 8 byte data is provided between the information data.

98 of the EFM frame having the above configuration are gathered to form 1 block unit. Upon recording of data, a synchronization pattern is added to EFM frame. Each 8 bit data is converted into 14 bit data with an additional margin bit of 3 bit data not shown.

The top portion of EFM frame has a subcode recorded with a time information. This means that the value always changes. However, the audio data has a fixed data of 24 bytes and the data for error correction also becomes a fixed data. In other words, each 12 byte data in 24 byte data is a fixed data of “0x00”.

The sequence of fixed data and unfixed data provide different surface condition that the reflection coefficient in the sequence of fixed data and unfixed data differs from each other. In this sense, the lead-in and lead-out areas and program area can visibly distinguished. For an example of the information recording disk 2, the reflection coefficient for lead-in and lead-out areas 2a1 and 2c1 are 75% approximately, and the reflection coefficient for the program area 2b1 is 76.5%, approximately.

The information recording disk 2 is recorded with unfixed data in each lead-in and lead-out area 2a1 and 2c1. 1 byte data contiguous to each other is not identical. For example, 6 bytes of left channel data “0x00, 0x05, 0x00, 0x05, 0x00, 0x05” and 6 bytes of right channel data “0x00, 0x12, 0x00, 0x12, 0x00, 0x12” are recorded as a 12 byte data sequence for predetermined time period.

FIG. 5 is a diagram for explaining an example of EFM frame format data according to the present invention. In FIG. 5, the EFM frame data constitutes 33 byte data and has a similar format to that shown in FIG. 4.

The data has 1 byte of subcode in the top portion and subsequently has 24 bytes of program data and 8 bytes of error correction code. 24 byte program data subsequently constitutes of 6 bytes of left channel data “0x00, 0x05, 0x00, 0x05, 0x00, 0x05”, and 6 bytes of right channel data “0x00, 0x12, 0x00, 0x12, 0x00, 0x12”, and 4 bytes of error correction code, and 6 bytes of left channel data “0x00, 0x05, 0x00, 0x05, 0x00, 0x05”, and 6 bytes of right channel data “0x00, 0x12, 0x00, 0x12, 0x00, 0x12”, and 4 byte of error correction code. All the 24 byte program data is unfixed data.

The lead-in area 3a1 and the lead-out area 3c1 are recorded with an information having data sequence of unfixed data respectively, which is inaudible sound, to make the difference of reflection coefficient in the program area 3b1 and lead-in and lead-out areas 3a1, 3c1 small as possible.

For example, the reflection coefficient of the lead-in and lead-out areas 3a1, 3c1 is determined to be in the range of 0.5% to 1.0% smaller than that of the program area 3b1. Specifically, when the reflection coefficient of the program area 3b1 is 76.5%, then the reflection coefficient of the lead-in and lead-out areas 3a1, 3c1 is determined to be 76.5%±(0.5% to 1.0%). The reflection coefficient for the lead-in and lead-out areas 3a1, 3c1 in this range makes distinguishing visually the lead-in and lead-out areas 3a1, 3c1 hard.

As described above, the physical position of the lead-in area 3a1 and lead-out area 3c1 is hard to be distinguished visually. The present invention is not limited to the above that it may also utilized in, for example, an area of “Index-0” of audio CD. The area of “Index-0” is the area between the audio tracks and usually recorded with the fixed data, which makes distinguishing visually the physical position of the track area easier. If the area of “Index-0” is recorded with the unfixed data as described above, the physical position of the tracks is hard to be distinguished visually. Consequently, the audio track to be protected by copyright can hardly be distinguished visually.

For example, there provided a technical standard for CD as a “Yellow Book” which specifies a data format of program area (i.e. a ROM area), and lead-in and lead-out areas of CD-ROM. The “Yellow Book” specified that the lead-in and lead-out areas generally have a CD-ROM structure but they may also have a structure same as the audio CD.

In the case of the information recording disk 3, the lead-in and lead-out areas in the second session S2 are set to have a CD-ROM structure but the lead-in and lead-out areas in the first session S1 may be set to have an audio CD structure. In other words, the lead-in and lead-out areas in the second session S2 are recorded with unfixed data but the lead-in/lead-out areas in the session 1 are recorded with fixed data.

The program area according to the present invention is described to have recorded with an audio data but it is not limited to this that it may also be recorded with other data, which should be protected under copyrights.

[Second Embodiment]

In order to achieve the object of present invention, the information recording disk may have a colored substrate in the recording side of the disk. By utilizing the colored substrate in the recording side of the disk, the physical positions of the lead-in area, program area and lead-out area are hard to be distinguished visually. However, it should be understood that a material for the colored substrate should not affect reproducing information from the recording side of the disk. Specifically, a colored substrate should not affect reflection of a laser beam radiated from an optical device incorporated in a reproducing apparatus to obtain a reproduced signal from the information recording disk.

For example, the colored substrate can be made by adding a colorant in a polycarbonate resin. The colored substrate is used for an information recording disk to make distinguishing visually physical position of protect areas hard. It should be noted that the colored substrate should make distinguishing visually the protect areas hard but should not affect reproducing signal from the recording side.

It is to be understood that the invention is not limited in its application to the details of structure and arrangement of parts illustrated in the accompanying drawings, since the invention is capable of other embodiments and of being practiced or carried out in various ways. Also it is to be understood that the phraseology or terminology employed herein is for the purpose of description and not of limitation.

What is claimed is:

1. A copy controlled information recording disk having a session structure comprising:
a lead-in area;
a program area; and
a lead-out area,
formed continuously in serial concentric circle in the radial direction,
the copy controlled information recording disk is further characterized in that each reflection coefficient of the lead-in area and the lead-out area is set to be equal to a reflection coefficient of the program area, and
that the reflection coefficient is set to be in a value that physical position of each area is hard to be distinguished visually.
